(19) United States
(12) Patent Application Publication
(10) Pub. No.: US 2014/0310081 A1
(43) Pub. Date: Oct. 16, 2014

(54) INFORMATION PROCESSING APPARATUS, INFORMATION PROCESSING METHOD, AND NON-TRANSITORY COMPUTER READABLE MEDIUM

(71) Applicant: Fuji Xerox Co., Ltd., Tokyo (JP)

(72) Inventor: Kazunaga HORIUCHI, Minato-ku (JP)

(73) Assignee: FUJI XEROX CO., LTD., Tokyo (JP)

(21) Appl. No.: 14/104,671

(22) Filed: Dec. 12, 2013

(30) Foreign Application Priority Data
Apr. 12, 2013 (JP) 2013-083933

(51) Int. Cl. G06Q 30/02

(52) U.S. Cl. CPC G06Q 30/0222
USPC 705/14.23

(57) ABSTRACT

An information processing apparatus includes a first information processing unit, a presenting unit, an accepting unit, and a second information processing unit. The first information processing unit performs first information processing for providing a user with a service. The presenting unit presents a question to the user. The accepting unit accepts an answer to the question from the user. The second information processing unit performs second information processing regarding a charge for the service. The second information processing unit performs, as the second information processing, processing for collecting a determined charge for the service from the user in a case where the accepting unit does not accept an answer from the user. The second information processing unit performs, as the second information processing, processing for discounting the determined charge or processing for not collecting the determined charge in a case where the accepting unit accepts an answer from the user.

### CROSS-REFERENCE TO RELATED APPLICATIONS

This application is based on and claims priority under 35 USC 119 from Japanese Patent Application No. 2013-083933 filed Apr. 12, 2013.

### BACKGROUND

### Technical Field

The present invention relates to an information processing apparatus, an information processing method, and a non-transitory computer readable medium.

### SUMMARY

According to an aspect of the invention, there is provided an information processing apparatus including a first information processing unit, a presenting unit, an accepting unit, and a second information processing unit. The first information processing unit performs first information processing for providing a user with a service. The presenting unit presents a question to the user, who utilizes the service provided in accordance with the first information processing performed by the first information processing unit. The accepting unit accepts an answer to the question presented by the presenting unit from the user. The second information processing unit performs second information processing regarding a charge for the service. The second information processing unit performs, as the second information processing, processing for collecting a determined charge for the service from the user in a case where the accepting unit does not accept an answer from the user. The second information processing unit performs, as the second information processing, processing for discounting the determined charge or processing for not collecting the determined charge in a case where the accepting unit accepts an answer from the user.

### BRIEF DESCRIPTION OF THE DRAWINGS

Exemplary embodiments of the present invention will be described in detail based on the following figures, wherein:

FIG. 1 is a diagram illustrating an example of the hardware configuration of an image forming apparatus according to a first exemplary embodiment of the present invention;

FIG. 2 is a diagram illustrating an example of the functional configuration of the image forming apparatus according to the first exemplary embodiment;

FIGS. 3A and 3B are diagrams illustrating examples of a presented question according to the first exemplary embodiment;

FIG. 4 is a diagram illustrating an example of a profit table according to the first exemplary embodiment;

FIG. 5 is a flowchart illustrating an example of the operation of the image forming apparatus in charging processing according to the first exemplary embodiment;

FIG. 6 is a diagram illustrating an example of a value information table according to a second exemplary embodiment;

FIG. 7 is a diagram illustrating an example of displayed selection images according to a third exemplary embodiment;

FIG. 8 is a diagram illustrating an example of a type-of-service table according to a fourth exemplary embodiment;

FIG. 9 is a diagram illustrating an example of a details-of-service table according to a fourth exemplary embodiment;

FIG. 10 is a diagram illustrating an example of a functional configuration according to a fifth exemplary embodiment;

FIG. 11 is a diagram illustrating an example of a relevance table according to the fifth exemplary embodiment;

FIG. 12 is a diagram illustrating an example of a profit table according to the fifth exemplary embodiment;

FIG. 13 is a diagram illustrating an example of a relevance table according to a sixth exemplary embodiment;

FIG. 14 is a diagram illustrating an example of a functional configuration according to an exemplary modification;

FIG. 15 is a diagram illustrating an example of displayed determination image according to the exemplary modification;

FIG. 16 is a diagram illustrating an example of a profit table according to the exemplary modification;

FIG. 17 is a diagram illustrating the functional configuration of an image forming apparatus according to an exemplary modification; and

FIG. 18 is a diagram illustrating an example of a target table according to an exemplary modification.

### DETAILED DESCRIPTION

### 1. First Exemplary Embodiment

### 1-1. Hardware Configuration

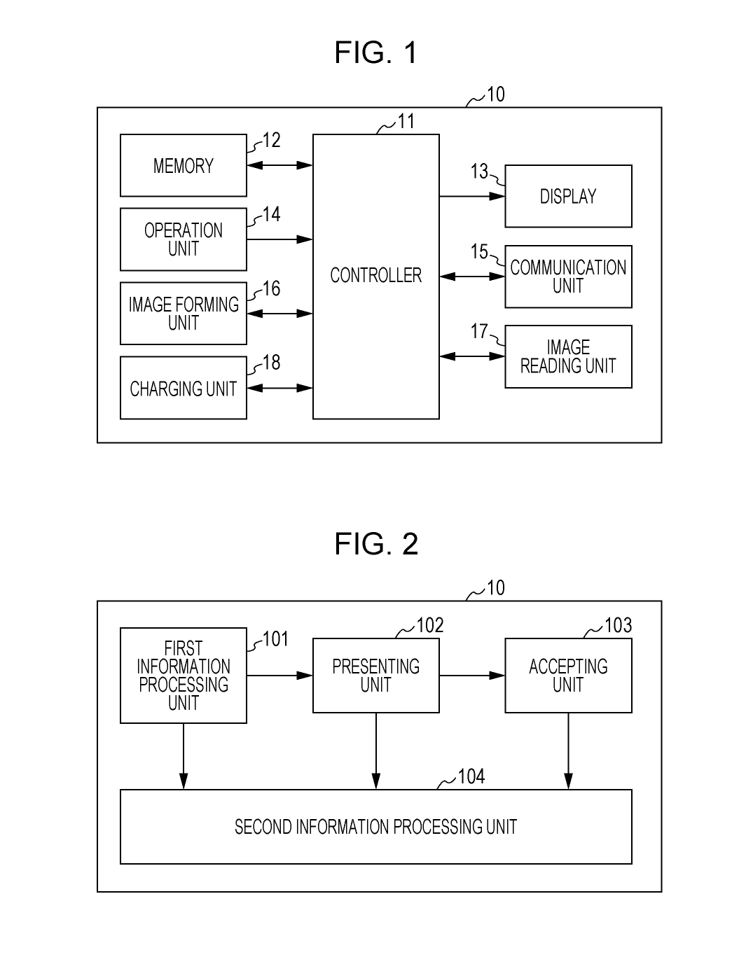

FIG. 1 is a diagram illustrating an example of the hardware configuration of an image forming apparatus 10. The image forming apparatus 10 provides a user with a service by, for example, forming an image on a medium such as a sheet, presents a question to the user, and accepts an operation of answering the question. A question presented by the image forming apparatus 10 is for acquiring an answer that may be utilized for marketing (an answer representing needs or an attribute of the user).

Examples of a service provided to the user include the following: a print service in which a photograph stored in a smart phone or the like, or an image on a designated website is output to a medium; a copy service in which an image on a sheet or the like is read and output to a medium; a scan service in which image data representing a read image is generated; and a facsimile service in which facsimile data is transmitted. In addition, a service of outputting an image representing content, such as information on surrounding areas, information on movies, information on learning, and information on sports (hereinafter referred to as a “content service”), is provided. In each of the above-described services, an image is output or read. Hereinafter, these services are referred to as “image services”. In the following exemplary embodiments, a description will be given of cases where an image service is provided to a user as an example of a “service”.

The image forming apparatus 10 is a computer that includes a controller 11, a memory 12, a display 13, an operation unit 14, a communication unit 15, an image forming unit 16, an image reading unit 17, and a charging unit 18. The controller 11 includes a central processing unit (CPU), a read only memory (ROM), a random access memory (RAM), and a real-time clock. The CPU executes a program stored in the ROM or the memory 12 by using the RAM as a working area, and thereby controls the operations of the individual devices. The real-time clock calculates the current date and time, and notifies the CPU.

The memory 12 includes a flash memory, a hard disk, or the like, and stores data and a program used by the controller 11 to perform control, and image data. The display 13 includes a liquid crystal display or the like, and displays an image on the display screen. The operation unit 14 includes operators such as a touch panel and buttons provided on the display screen, and serves as an accepting unit that accepts a user operation. Operation data corresponding to a user operation accepted by the operation unit 14 is supplied to the controller 11, and thereby the controller 11 performs processing in accordance with the operation data.

The communication unit 15 includes a communication circuit for performing communication, and communicates with an external apparatus. The communication unit 15 is connected to a network such as the Internet (not illustrated), and communicates with an external apparatus via the network. The communication unit 15 supplies data received through communication to the controller 11. The image forming unit 16 forms an image on a medium such as a sheet. For example, the image forming unit 16 forms an image on a sheet by using an electrophotographic system and toners of four colors, yellow (Y), magenta (M), cyan (C), and black (K). The image forming unit 16 forms an image representing image data on a recording medium so as to output the image data onto the medium, for example, when a facsimile function or an image formation function is implemented. The image reading unit 17 optically reads an image formed on a medium such as a sheet. The image reading unit 17 supplies image data representing the read image to the controller 11.

The charging unit 18 charges a user who has utilized a service, and deals with money, including coins and bills, and electronic money. The charging unit 18 includes, for example, a collecting unit that collects money including coins and bills, and a giving unit that gives change. Upon receiving a notification indicating an amount to be charged from the controller 11, the charging unit 18 determines whether or not the amount of money collected by the collecting unit is equal to or larger than the amount indicated in the notification. If the determination result is negative, the charging unit 18 waits until more money is collected. If the charging unit 18 determines that the amount of collected money is larger than the amount indicated in the notification, the giving unit gives change. In a case where electronic money is used, the charging unit 18 performs the above-described collecting and giving processing through communication compatible with, for example, near field communication (NFC). The collecting and giving processing performed by the charging unit 18 is hereinafter referred to as “collection processing”.

### 1-2. Functional Configuration

The image forming apparatus 10 accepts an answer to a presented question from a user, and performs charging processing of charging a user for a service provided to the user, by using the above-described hardware configuration. The memory 12 stores a program for performing charging processing. The controller 11 executes the program and controls the individual units, and thereby the functions described below are implemented.

FIG. 2 is a diagram illustrating an example of the functional configuration of the image forming apparatus 10. The image forming apparatus 10 includes a first information processing unit 101, a presenting unit 102, an accepting unit 103, and a second information processing unit 104.

### 1-2-1. First Information Processing Unit 101

The first information processing unit 101 is an example of a unit that performs first information processing for providing a user with an image service. In this exemplary embodiment, an image service is provided for pay. That is, the first information processing unit 101 performs first information processing for providing a charge-paying image service. The first information processing unit 101 performs, as first information processing, processing corresponding to an image service to be provided. Examples of the first information processing will be described below.

The first information processing unit 101 is a function implemented by the controller 11, the display 13, the communication unit 15, the image forming unit 16, and the image reading unit 17. For example, in a print service, image data transmitted from an external apparatus, such as a smart phone or a web server, is supplied to the controller 11 via the communication unit 15, and the controller 11 controls the image forming unit 16 to output an image represented by the image data to a medium. In a scan service, image data of an image read by the image reading unit 17 is supplied to the controller 11, and the controller 11 causes the display 13 to display the image data and transmits the image data to a destination designated by a user via the communication unit 15. In a content service, the controller 11 controls the image forming unit 16 to output content stored in advance in the memory 12 or content supplied from an external apparatus via the communication unit 15 to a medium. These are examples of the first information processing.

The first information processing unit 101 performs the above-described first information processing, and notifies the second information processing unit 104 of the details of the image service provided on the basis of the first information processing. The details of the image service correspond to, for example, in a content service, information representing the number of sheets of content that have been output and the price per sheet. The information is used by the user to calculate the amount to pay.

At the timing when provision of an image service is started through first information processing, the first information processing unit 101 notifies the presenting unit 102 of the start. For example, in a print service or content service, the first information processing unit 101 transmits a notification at the timing when an operation for starting output of an image is performed by a user after the type of sheet and the number of sheets have been selected. In a copy service or scan service, the first information processing unit 101 transmits a notification at the timing when an operation for starting copying or scanning is performed by a user after a sheet has been set.

### 1-2-2. Presenting Unit 102

The presenting unit 102 is an example of a unit that presents a question to a user who utilizes a service provided on the basis of first information processing performed by the first information processing unit 101. The presenting unit 102 is a function implemented by, for example, the controller 11, the memory 12, and the display 13. In this exemplary embodiment, the memory 12 stores questions for acquiring answers that may be utilized for marketing from a user. Specifically, the memory 12 stores, for example, questions regarding physical features, such as age and sex, questions regarding a living environment, such as a present address and family makeup, questions regarding skills, such as occupation and special ability, questions regarding preference, such as a hobby and collection, questions regarding a field of items in which a user is interested, and questions regarding a plan of activities.

In response to a notification indicating that provision of an image service has been started from the first information processing unit 101, the presenting unit 102 calls any one of the questions stored in the memory 12 and causes the display 13 to display the question, so as to present the question to a user.

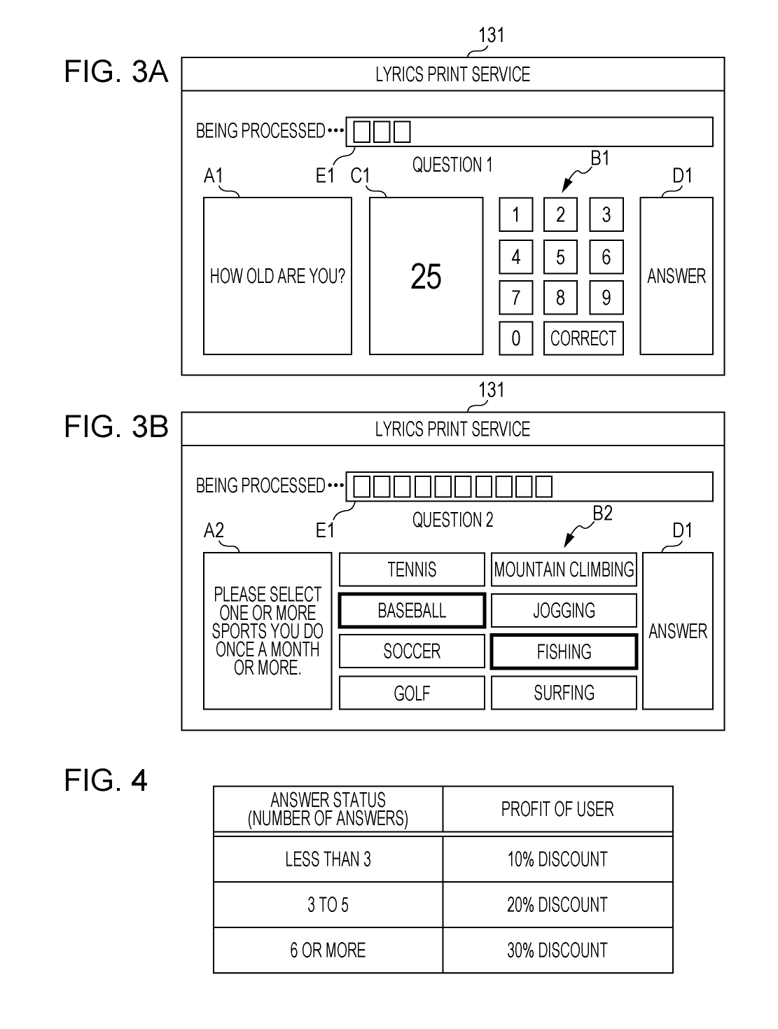

FIGS. 3A and 3B are diagrams illustrating examples of a presented question. In FIG. 3A, a character string “Question 1” and an image A1 representing a question with a character string “How old are you?” (hereinafter referred to as a “question image”) are displayed on a display screen 131 of the display 13. In FIG. 3B, a character string “Question 2” and a question image A2 including a character string “Please select one or more sports you do once a month or more.” are displayed on the display screen 131. The presenting unit 102 presents the question in this way, and notifies the accepting unit 103 and the second information processing unit 104 of the presented question.

The presenting unit 102 causes the display screen 131 to display an image E1 representing a status in which processing regarding the image service provided by the first information processing unit 101 (hereinafter referred to as “service processing”) is progressing (progress status). Hereinafter, such an image is referred to as a “progress status image”. The progress status image E1 represents a progress status by the proportion of an image of a small rectangle to the surrounding rectangular area. In this exemplary embodiment, the presenting unit 102 continues to present a question until the progress status image E1 indicates the end of processing (until service processing is finished). Upon finishing presentation of the question, the presenting unit 102 notifies the second information processing unit 104 of it.

### 1-2-3. Accepting Unit 103

The accepting unit 103 is an example of a unit that accepts an answer to a question presented by the presenting unit 102 from a user. The accepting unit 103 is a function implemented by, for example, the controller 11, the memory 12, the display 13, and the operation unit 14. The memory 12 stores an image representing an operator (hereinafter referred to as an “operator image”) that is used for answering a question represented by the question image illustrated in FIG. 3A or 3B. The controller 11 causes the display 13 to display an operator image corresponding to the question indicated by the presenting unit 102.

In the example illustrated in FIG. 3A, an operator image B1 that is displayed by the controller 11 is illustrated. The operator image B1 is an image representing plural operators, including ten numerals “0” to “9” and a character string “Correct”. A user operates the operator image B1 to input numerals, and thereby the operation unit 14 supplies operation data representing an answer of the user to the controller 11. In this example, operation data representing input of numerals “2” and “5” is supplied, and the controller 11 causes an answer image C1 including a character string “25” to be displayed, which is an image representing an answer to the question represented by the question image A1. Also, the controller 11 causes an image D1 that includes a character string “Answer” and is used for confirming the answer (hereinafter referred to as a “confirmation image”) to be displayed on the display 13. In response to an operation of selecting the confirmation image D1 by the user, the controller 11 accepts the answer represented by the answer image C1 (in this example, the answer “25”) as an answer to the question represented by the question image A1.

In the example illustrated in FIG. 3B, an operator image B2 that is displayed by the controller 11 is illustrated. The operator image B2 is an image representing plural operators including plural names of sports, “tennis”, “baseball”, “soccer”, “golf”, “mountain climbing”, “jogging”, “fishing”, and “surfing”. A user operates the operator image B2 to select one or plural operators, and thereby the operation unit 14 supplies operation data representing an answer of the user to the controller 11. In this example, operation data representing the operators including “baseball” and “fishing” is supplied, and the controller 11 causes the image of the operators representing the answer to the question represented by the question image A2 to be displayed in an emphasized manner (in this example, with a bold outline). When the user performs an operation of selecting the confirmation image D1, the controller 11 accepts an answer represented by the emphasized operators in the operator image B2 (in this example, an answer “baseball” and “fishing”) as an answer to the question represented by the question image A2. The accepting unit 103 accepts the answer from the user in the above-described manner, and notifies the second information processing unit 104 of the accepted answer.

In the examples illustrated in FIGS. 3A and 3B, the accepting unit 103 accepts input numerals or options selected from among eight options as an answer to the question. Alternatively, for example, the accepting unit 103 may accept input “kana” characters in the Japanese syllabary or alphabetic characters as an answer, or may accept an option selected from among two options, not among eight options, as an answer. Further, the number of options selected by a user may be limited to a certain number, for example, one or two. Alternatively, the number may not be limited, as in the example illustrated in FIG. 3B.

### 1-2-4. Second Information Processing Unit 104

The second information processing unit 104 is an example of a unit that performs processing regarding the charge of an image service (hereinafter referred to as “second information processing”). In this exemplary embodiment, the second information processing unit 104 performs, as second information processing, processing for providing a user with a profit whose amount corresponds to the status of answers accepted by the accepting unit 103 from the user (hereinafter referred to as an “answer status”). More specifically, the second information processing unit 104 performs, as second information processing, processing for discounting a predetermined charge for an image service (hereinafter referred to as a “service charge”) in accordance with an accepted answer status (this is the processing for providing the user with the above-described profit). Here, the “answer status” is a status regarding the answers made by the user, for example, the number of answers made by the user from the start to the end of presentation of questions performed by the presenting unit 102. The second information processing unit 104 is a function implemented by, for example, the controller 11, the memory 12, and the charging unit 18. The memory 12 stores a profit table in which answer statuses (in this example, the numbers of answers) and the amounts of profit are associated with each other.

FIG. 4 is a diagram illustrating an example of the profit table. In this example, profits of a user “10% discount”, “20% discount”, and “30% discount” are associated with answer statuses (the numbers of answers) “less than 3”, “3 to 5”, and “6 or more”, respectively. The controller 11 is notified of accepted answers by the accepting unit 103, and is notified of the end of presentation of questions by the presenting unit 102. The controller 11 refers to the profit of the user associated in the profit table with the number of answers that have been made until the end of presentation of questions is reported. For example, in a case where the number of answers is 5, the controller 11 refers to the profit “20% discount”, which is associated with “3 to 5”.

Also, the controller 11 is notified of, by the first information processing unit 101, the details of the image service that has been provided (for example, the number of output sheets of content and the price per sheet). For example, in a lyrics print service, it is assumed that the controller 11 is notified of the details indicating that five sheets of lyrics have been output and it costs 50 yen per sheet. Then, the controller 11 calculates the amount to be charged to the user on the basis of the details (in this example, 50 yen×5=250 yen). The amount calculated in this way corresponds to a service charge of the image service provided on the basis of first information processing performed by the first information processing unit 101.

The controller 11 discounts the service charge so that the profit that has been referred to is provided to the user. In a case where the profit of the user is 20% discount, as in the above-described example, the controller 11 calculates the amount “200 yen”, which is a discount of 20% (50 yen) from 250 yen. The controller 11 notifies the charging unit 18 of the calculated amount as an amount to be charged. The charging unit 18 performs collection processing on the basis of the amount. The collection processing is included in the second information processing. In the amount charged in this way, the profit of the user (in this example, 50 yen) is reflected. That is, the user is provided with the profit corresponding to the discounted amount. As described above, the second information processing unit 104 performs, as second information processing, processing for discounting a service charge in accordance with an answer status, that is, processing for providing a user with a profit whose amount corresponds to an answer status.

The second information processing unit 104 may perform processing for not collecting a service charge in accordance with an answer status, in addition to or instead of the above-described discount processing. In this case, for example, the second information processing unit 104 performs processing for not collecting a service charge in a case where the number of answers is 10 or more. The processing for not collecting a service charge is, for example, processing for notifying the charging unit 18 that the amount to be charged is 0 yen, or processing for not notifying the charging unit 18.

In this way, the second information processing unit 104 may perform, as processing for providing a user with a profit whose amount corresponds to an answer status, processing for discounting a service charge in accordance with an answer status or processing for not collecting a service charge in accordance with an answer status.

### 1-2-5. Answer Status

An example of the answer status is not limited to the number of answers. The answer status may be, for example, the time period from when a question is presented to when an answering operation is accepted, that is, the time period taken for making an answer (hereinafter referred to as an “answering time”). In a case where a user answers plural questions, the second information processing unit 104 regards the average or median of the time periods taken for making answers as an answering time. If the time taken for the above-described service processing is common, it is estimated that a user whose answering time is short has answered more questions than a user whose answering time is long. In this case, the second information processing unit 104 performs, as second information processing, processing for providing a first user whose answering time is shorter than a second user with a profit whose amount is larger than a profit for the second user.

In association with an answer accepted by the accepting unit 103, information identifying the user who has made the answer (hereinafter referred to as “user identification information”) may be acquired. This may occur, for example, in a case where collection processing is performed by the charging unit 18 through near field communication (NFC), and user identification information is acquired through the communication. In this case, the second information processing unit 104 may regard the number of or the time period for the answers associated with the user identification information of the user who has answered questions, that is, the answers made by the user, as an answer status.

For example, it is estimated that a user who has answered many questions before will answer more questions than a user who has answered less questions before. The second information processing unit 104 performs second information processing for providing a user with a profit whose amount corresponds to the number of answers including those made before (or an answering time). More specifically, the second information processing unit 104 performs, as second information processing, processing for providing a first user who has answered more questions than a second user before with a larger profit than that for the second user, or processing for providing a first user whose answering time is shorter than a second user with a larger profit than that for the second user.

That is, an answer status is a status of answers accepted by the accepting unit 103, that is, a status of answers that have been made by a user. Any type of status may be used as long as the number of answers that have been made by a user and the number of answers that will be made by the user may be estimated therefrom.

### 1-3. Operation

The image forming apparatus 10 performs the above-described charging processing (processing for charging a user for a provided service) by using the above-described configuration. Hereinafter, the operation performed by the image forming apparatus 10 in the charging processing will be described.

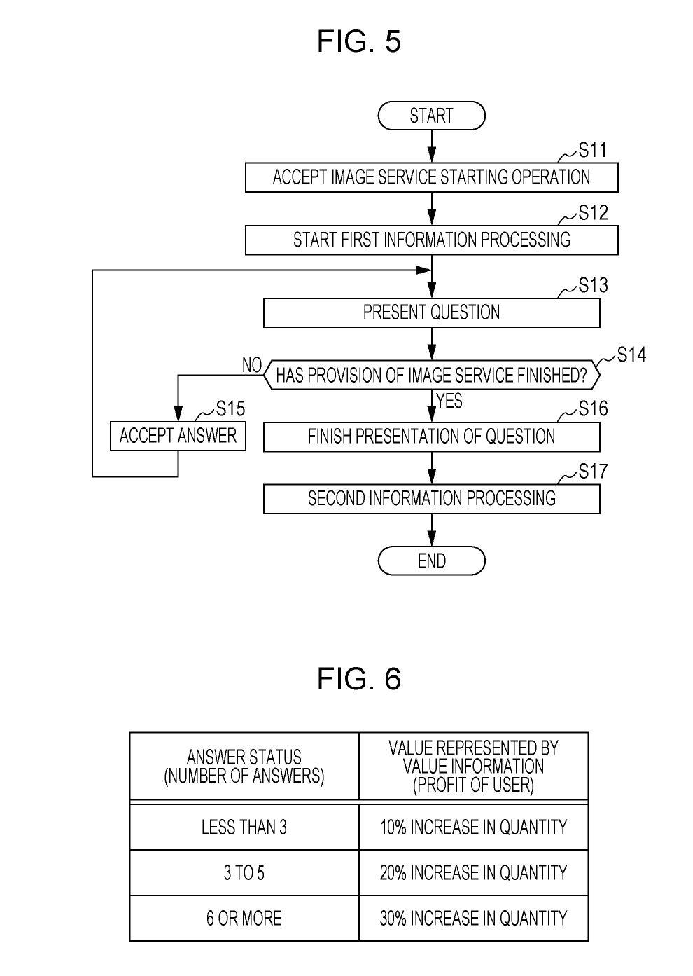

FIG. 5 is a flowchart illustrating an example of the operation performed by the image forming apparatus 10 in the charging processing. The charging processing is started upon a user operation of starting an image service (hereinafter referred to as a “starting operation”).

First, the image forming apparatus 10 accepts a starting operation of starting an image service from the user (step S11), and starts the above-described first information processing (step S12). Accordingly, the image service based on the first information processing is provided to the user. Steps S11 and S12 are performed by the first information processing unit 101. Subsequently, the image forming apparatus 10 presents a question, for example, the question illustrated in FIG. 3A or 3B, to the user (step S13). Step S13 is performed by the presenting unit 102. Subsequently, in this exemplary embodiment, the image forming apparatus 10 determines whether or not provision of the image service has finished (step S14). If the image forming apparatus 10 determines that provision of the image service has not finished (NO), the image forming apparatus 10 accepts an answer to a question from the user (step S15). Step S15 is performed by the accepting unit 103.

After step S15 (acceptance of an answer), the process returns to step S13 (presentation of a question), where the image forming apparatus 10 performs an operation. If the image forming apparatus 10 determines in step S14 that provision of the image service has finished (YES), the image forming apparatus 10 finishes presentation of the question (step S16). Step S16 is performed by the presenting unit 102. Subsequently, the image forming apparatus 10 performs processing regarding the charge of the image service, that is, second information processing (step S17). In this exemplary embodiment, the image forming apparatus 10 performs processing for discounting the service charge in accordance with an answer status, that is, the number of answers accepted in step S15, and performs charging processing in which the profit of the user is reflected. Step S17 is performed by the second information processing unit 104. Then, the image forming apparatus 10 finishes the charging processing.

### 2. Second Exemplary Embodiment

Hereinafter, a description will be given of a second exemplary embodiment of the present invention, mainly of a point different from that of the first exemplary embodiment. In the first exemplary embodiment, a profit is provided to a user in the method of discounting the charge of an image service. In the second exemplary embodiment, a profit is provided to the user using a different method.

### 2-1. Functional Configuration

The second information processing unit 104 according to this exemplary embodiment performs, as second information processing, processing for outputting information representing a value that is to be utilized in commercial transactions (hereinafter referred to as “value information”). Examples of commercial transactions include purchasing an item, and paying for benefits of transportation or lodgment. Value information is utilized in a case where commercial transactions are performed in, for example, a specific store or specific electronic commercial transaction site. Examples of value information include so-called coupons and points. If such value information is utilized in commercial transactions, the user is provided with a value in which the price of an item is discounted, or a value in which, in the case of purchasing an item at a certain price, the number of items or a period for which the item is used (for example, the rental period of a rental video) is increased, or the quality or grade of the item is enhanced. Such a value represents a profit provided to the user.

The second information processing unit 104 performs, as second information processing, processing for outputting value information representing a value whose degree corresponds to an accepted answer status of the user. That is, the second information processing unit 104 performs processing for outputting value information as processing for providing the user with a profit whose amount corresponds to the answer status described in the first exemplary embodiment. In this exemplary embodiment, the second information processing unit 104 is implemented by, for example, the controller 11, the memory 12, the communication unit 15, and the image forming unit 16. The memory 12 stores a value information table in which answer statuses and values represented by value information are associated with each other.

FIG. 6 is a diagram illustrating an example of the value information table. In this example, values represented by value information (profit of the user) “10% increase in quantity”, “20% increase in quantity”, and “30% increase in quantity” are associated with answer statuses (the numbers of answers) “less than 3”, “3 to 5”, and “6 or more”. The values illustrated in FIG. 6 are utilized in commercial transactions in which items sold by measure in units of grams, such as meat and prepared food, are purchased.

The controller 11 specifies the value associated in the value information table with the number of answers that is based on a notification from the accepting unit 103 or a notification from the presenting unit 102, and causes value information representing the specified value to be output to a medium by controlling the image forming unit 16. Also, the controller 11 causes the value information to be output to a communication terminal of the user via the communication unit 15. By showing the value information output in this way to a salesperson in a store when purchasing an item, the user is provided with a value. For example, in the example illustrated in FIG. 6, in a case where the number of answers is 5, a value, that is, a profit in which the quantity of the item to be purchased is increased by 20%, is provided to the user. The second information processing unit 104 performs second information processing (processing for outputting value information) according to this exemplary embodiment in the above-described manner.

### 3. Third Exemplary Embodiment

Hereinafter, a description will be given of a third exemplary embodiment of the present invention, mainly of a point different from that of the first and second exemplary embodiments. In the first exemplary embodiment, a profit is provided to a user in the method of discounting the charge of an image service (hereinafter referred to as a “first method”). In the second exemplary embodiment, a profit is provided to a user in the method of outputting value information (hereinafter referred to as a “second method”). In the third exemplary embodiment, any one or both of these methods are selected by a user. Hereinafter, the method of implementing both the first and second methods is referred to as a “third method”.

### 3-1. Functional Configuration

In this exemplary embodiment, the second information processing unit 104 performs, as second information processing, the one selected by a user from among processing for discounting the charge of an image service in accordance with an answer status, processing for not collecting a service charge in accordance with an answer status, and processing for outputting value information representing a value which is utilized in commercial transactions and whose degree corresponds to an answer status, in order to provide the user with a profit whose amount corresponds to the above-described answer status. The user may select one, two, or three processing operations.

In this exemplary embodiment, the second information processing unit 104 is implemented by, for example, the controller 11, the memory 12, the display 13, and the operation unit 14. The memory 12 stores images for allowing a user to select processing (hereinafter referred to as “selection images”). The controller 11 causes the display 13 to display the selection images, for example, when the first information processing unit 101 finishes providing a service and the presenting unit 102 finishes presenting a question.

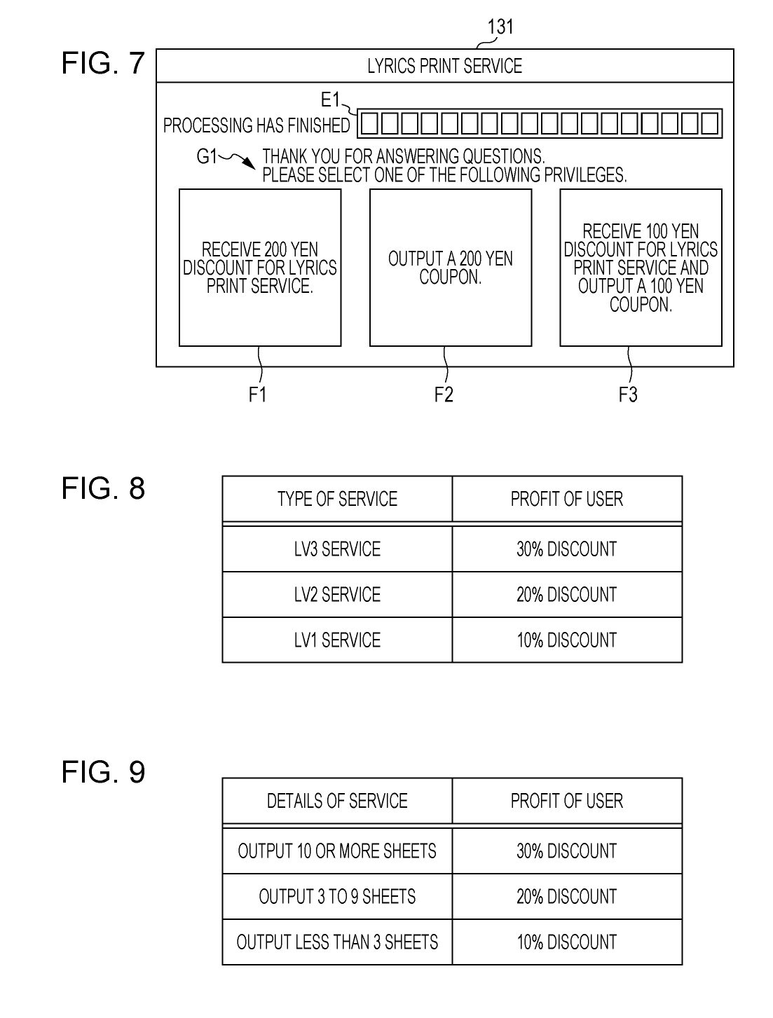

FIG. 7 is a diagram illustrating an example of displayed selection images. In this example, a selection image F1 including a character string “Receive 200 yen discount for lyrics print service.”, a selection image F2 including a character string “Output a 200 yen coupon.”, and a selection image F3 including a character string “Receive 100 yen discount for lyrics print service and output a 100 yen coupon.” are displayed on the display screen 131. Also, a progress status image E1 representing that provision of an image service based on first information processing has finished, and a character string G1 “Thank you for answering questions. Please select one of the following privileges.” are displayed on the display screen 131. The selection images F1, F2, and F3 correspond to the above-described first, second, and third methods, respectively. In response to a user operation of selecting any one of the selection images F1, F2, and F3 on the display screen 131 illustrated in FIG. 7, the second information processing unit 104 performs, as second information processing, processing for providing a user with a profit in the method corresponding to the selected selection image.

### 4. Fourth Exemplary Embodiment

Hereinafter, a description will be given of a fourth exemplary embodiment of the present invention, mainly of a point different from that of the above-described exemplary embodiments.

### 4-1. Functional Configuration

In the fourth exemplary embodiment, the second information processing unit 104 performs, as second information processing, processing for changing the amount of profit in accordance with the type or details of an image service that is provided on the basis of first information processing performed by the first information processing unit 101. Here, examples of the type of image service include various content services, such as the above-described print service, copy service, scan service, and facsimile service.

First, a description will be given of a case where the amount of profit changes in accordance with the type of image service. The second information processing unit 104 stores a type-of-service table in which the types of image services and the amounts of profit are associated with each other.

FIG. 8 is a diagram illustrating an example of the type-of-service table. In this example, profits of a user “30% discount”, “20% discount”, and “10% discount” are associated with the types of image services “LV3 service”, “LV2 service”, and “LV1 service”, respectively. LV3 service, LV2 service, and LV1 service are the types of image services in a case where the average price of output content per medium is classified into three levels (LV represents a level). Specifically, for example, the average price is 300 yen or more, 100 yen or more and less than 300 yen, and less than 100 yen.

In a case where a content service in which an average price is 200 yen is provided, the second information processing unit 104 performs, as second information processing, processing for providing a user with the profit “20% discount”, which is associated with “LV2 service” in the type-of-service table. In a case where a print service in which an average price is 30 yen is provided, the second information processing unit 104 performs, as second information processing, processing for providing a user with the profit “10% discount”, which is associated with “LV1 service” in the type-of-service table. In this way, the second information processing unit 104 performs, as second information processing, processing for providing a user with a profit corresponding to the type of provided image service.

A description will be given of a case where the amount of profit changes in accordance with the details of an image service. The second information processing unit 104 stores a details-of-service table in which the details of an image service and the amounts of profit are associated with each other.

FIG. 9 is a diagram illustrating an example of the details-of-service table. In this example, profits of a user “30% discount”, “20% discount”, and “10% discount” are associated with the details of an image service “output 10 or more sheets”, “output 3 to 9 sheets”, and “output less than 3 sheets”, respectively.

In a case where an image service in which images are output to 10 or more media is provided by the first information processing unit 101, for example, the second information processing unit 104 performs, as second information processing, processing for providing a user with the profit “30% discount”, which is associated with “output 10 or more sheets” in the details-of-service table. In a case where the number of sheets is 2, the second information processing unit 104 performs, as second information processing, processing for providing a user with the profit “10% discount”, which is associated with “less than 3 sheets” in the details-of-service table. As described above, the second information processing unit 104 performs, as second information processing, processing for providing a user with a profit corresponding to the details of a provided image service.

### 5. Fifth Exemplary Embodiment

Hereinafter, a description will be given of a fifth exemplary embodiment of the present invention, mainly of a point different from that of the above-described exemplary embodiments.

### 5-1. Functional Configuration

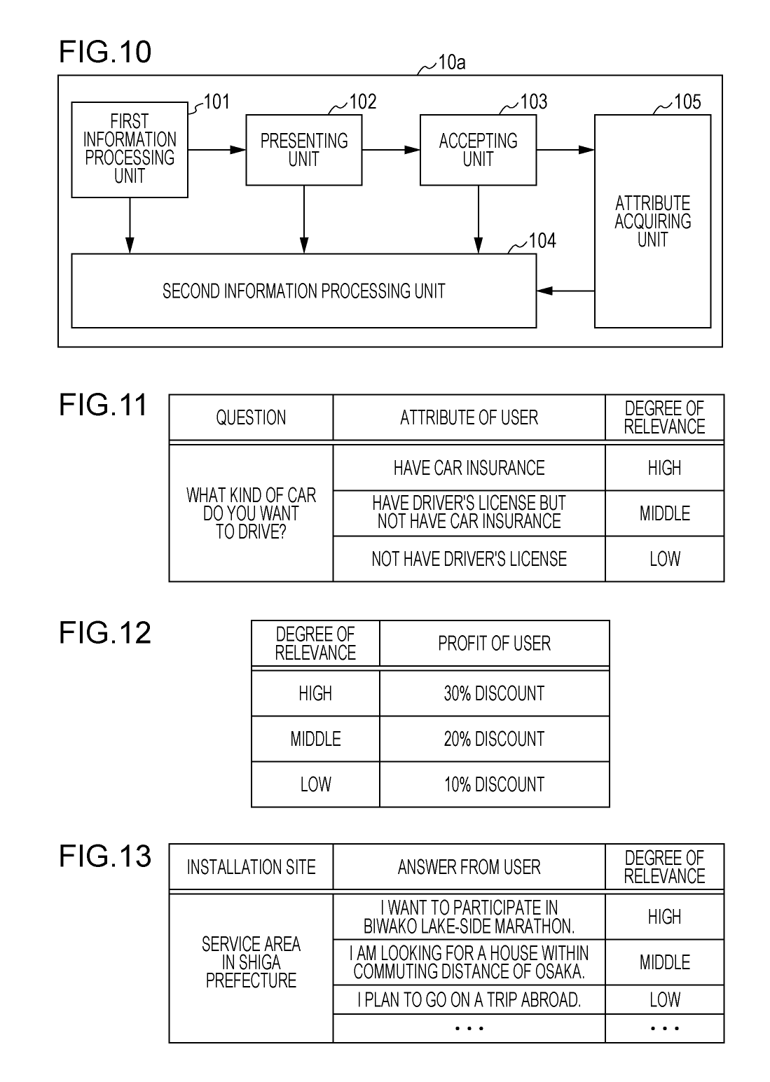

FIG. 10 is a diagram illustrating an example of the functional configuration according to a fifth exemplary embodiment. FIG. 10 illustrates an image forming apparatus 10a including an attribute acquiring unit 105, in addition to the units illustrated in FIG. 2.

The attribute acquiring unit 105 is an example of a unit that acquires attributes of a user. The attributes of a user include, for example, attributes regarding physical features, such as age and sex, attributes regarding a living environment, such as a present address and family makeup, attributes regarding skills, such as occupation and special ability, attributes regarding preference, such as a hobby and collection, attributes regarding a field of items in which a user is interested, and attributes regarding a plan of activities. The attribute acquiring unit 105 is implemented by, for example, the controller 11, the memory 12, the display 13, the operation unit 14, and the communication unit 15. The controller 11 causes the display 13 to display an image which allows a user to input an attribute of the user, and acquires the attribute of the user on the basis of operation data supplied from the operation unit 14 when the user inputs the attribute by viewing the image.

The method for acquiring an attribute of a user by the attribute acquiring unit 105 is not limited to that described above. For example, in a case where communication with a communication terminal of a user is performed via the communication unit 15 in a print service and image data is transmitted, attribute data representing an attribute of the user may also be transmitted, so that the attribute acquiring unit 105 acquires the attribute of the user. Also, the attribute acquiring unit 105 may acquire an answer accepted from the user by the accepting unit 103 as an attribute of the user. For example, in the examples illustrated in FIGS. 3A and 3B, information about the age of the user and the sports which the user do every month, accepted by the accepting unit 103, is acquired as attributes by the attribute acquiring unit 105. The attribute acquiring unit 105 notifies the second information processing unit 104 of the acquired attributes of the user.

In this exemplary embodiment, the second information processing unit 104 performs, as second information processing, processing for changing the amount of profit in accordance with the relationship between the attribute acquired by the attribute acquiring unit 105 and the question presented by the presenting unit 102 or the answer accepted by the accepting unit 103 from the user. Here, the relationship is represented by, for example, the degree of relevance between the question and the attribute of the user. The second information processing unit 104 stores, for example, a relevance table in which a question, the attributes of a user, and the degrees of relevance therebetween are associated with one another.

FIG. 11 is a diagram illustrating an example of the relevance table. In this example, the attributes of a user “have car insurance”, “have driver's license but not have car insurance”, and “not have driver's license”, and the degrees of relevance “high”, middle”, and “low” are associated with each other regarding the question “What kind of car do you want to drive?”. When this question is presented, the second information processing unit 104 specifies the degree of relevance in accordance with an acquired attribute of the user (for example, if an attribute “have car insurance” is acquired, the degree of relevance is specified to be “high”).

The second information processing unit 104 stores a profit table in which the degrees of relevance and the profits of a user are associated with each other.

FIG. 12 is a diagram illustrating an example of the profit table. In this example, profits of a user “30% discount”, “20% discount”, and “10% discount” are associated with the degrees of relevance “high”, “middle”, and “low”, respectively. The second information processing unit 104 performs, as second information processing, processing for providing a user with the profit associated in the profit table with the degree of relevance specified using the relevance table illustrated in FIG. 11 (for example, if the degree of relevance is “high”, processing for providing a user with the profit “30% discount” is performed as second information processing). As described above, the second information processing unit 104 performs, as second information processing, processing for changing the amount of profit in accordance with the relationship between an acquired attribute and the question presented by the presenting unit 102 (in this example, the relationship represented by the degree of relevance).

Alternatively, the second information processing unit 104 may store a relevance table in which answers of a user instead of questions, the attributes of the user, and the degrees of relevance are associated with one another. Accordingly, the second information processing unit 104 performs, as second information processing, processing for changing the amount of profit in accordance with the relationship between the attribute acquired by the attribute acquiring unit 105 and the answer accepted by the accepting unit 103 from the user.

The second information processing unit 104 may perform second information processing by using another relationship instead of the above-described relevance. For example, in a case where a question is related to a specific area and where the attribute of the user indicates an area where the user lives now or lived in the past, the distance between these areas may be used as the above-described relationship. In this case, the second information processing unit 104 performs second information processing so that the amount of profit to be provided increases as the distance between these areas decreases. In a case where a question is related to a specific era and where the attribute of the user indicates his/her age or birth date, the age of the user in the specific era may be used as the above-described relationship. In this case, the second information processing unit 104 performs second information processing so that a different amount of profit is provided in accordance with whether the user is a child, a student, or a member of society at the time when the question is presented.

### 6. Sixth Exemplary Embodiment

Hereinafter, a description will be given of a sixth exemplary embodiment of the present invention, mainly of a point different from that of the above-described exemplary embodiments. In the above-described fifth exemplary embodiment, a profit is provided on the basis of an attribute of a user. In the sixth exemplary embodiment, a profit is provided on the basis of a site where the image forming apparatus 10 is installed (hereinafter referred to as an “installation site”).

### 6-1. Functional Configuration

In this exemplary embodiment, the second information processing unit 104 performs, as second information processing, processing for changing the amount of profit in accordance with the relationship between the site where the image forming apparatus 10 is installed (installation site) and the question presented by the presenting unit 102 or the answer accepted by the accepting unit 103 from the user. The relationship is represented by, as in the fifth exemplary embodiment, the degree of relevance between an installation site and a question or an answer of the user. The second information processing unit 104 stores, for example, a relevance table in which an installation site, answers of users, and the degrees of relevance therebetween are associated with one another.

FIG. 13 is a diagram illustrating an example of the relevance table. In this example, answers of users “I want to participate in Biwako lake-side marathon.”, “I am looking for a house within commuting distance of Osaka.”, and “I plan to go on a trip abroad.”, and the degrees of relevance “high”, “middle”, and “low” are associated with each other regarding the installation site “Service area in Shiga prefecture”. Note that FIG. 13 illustrates part of answers from users. Upon an answer being accepted from a user, the second information processing unit 104 specifies the degree of relevance in accordance with the answer (for example, in a case where an answer “I want to participate in Biwako lake-side marathon.” is accepted, the degree of relevance is specified to be “high”). The second information processing unit 104 performs second information processing by using the specified degree of relevance and the profit table illustrated in FIG. 12.

### 7. Exemplary Modifications

Each of the above-described exemplary embodiments is merely an example of the embodiment of the present invention, and may be modified in the following manner. Further, the above-described exemplary embodiments and the exemplary modifications described below may be implemented in combination with one another.

### 7-1. Method for Presenting Question

In the above-described exemplary embodiments, the presenting unit 102 presents a question to a user by using an image. Alternatively, the presenting unit 102 may present a question by using sound. In this case, the presenting unit 102 includes a unit that outputs sound, such as a speaker, and outputs sound representing a question. Also, the presenting unit 102 may include a unit that forms Braille characters representing a designated character string, so as to represent a question by using Braille characters. Also, the presenting unit 102 may present a question to a user via an external apparatus. In this case, for example, the presenting unit 102 transmits question data representing a question to a communication terminal of a user via the communication unit 15, and the communication terminal displays the question represented by the question data, so that the question is presented. In this way, the presenting unit 102 may present a question to a user by using any method.

### 7-2. Period Over which Question is Presented

In the above-described exemplary embodiments, the presenting unit 102 continues to present a question from when service processing is started to when the service processing is finished. Alternatively, the presenting unit 102 may continue to present the question even after the service processing has finished, or may finish presenting the question before the service processing is finished. Alternatively, the presenting unit 102 may start presenting the question before the service processing is started, or may present the question after a determined time period has elapsed from the start of the service processing. In any case, it is desirable that the presenting unit 102 present a question in a period where the user answers to the question more easily than in the other period.

### 7-3. User Determines the Number of Questions

In the above-described exemplary embodiments, the presenting unit 102 presents a question in a determined period. Alternatively, the presenting unit 102 may present a determined number of questions.

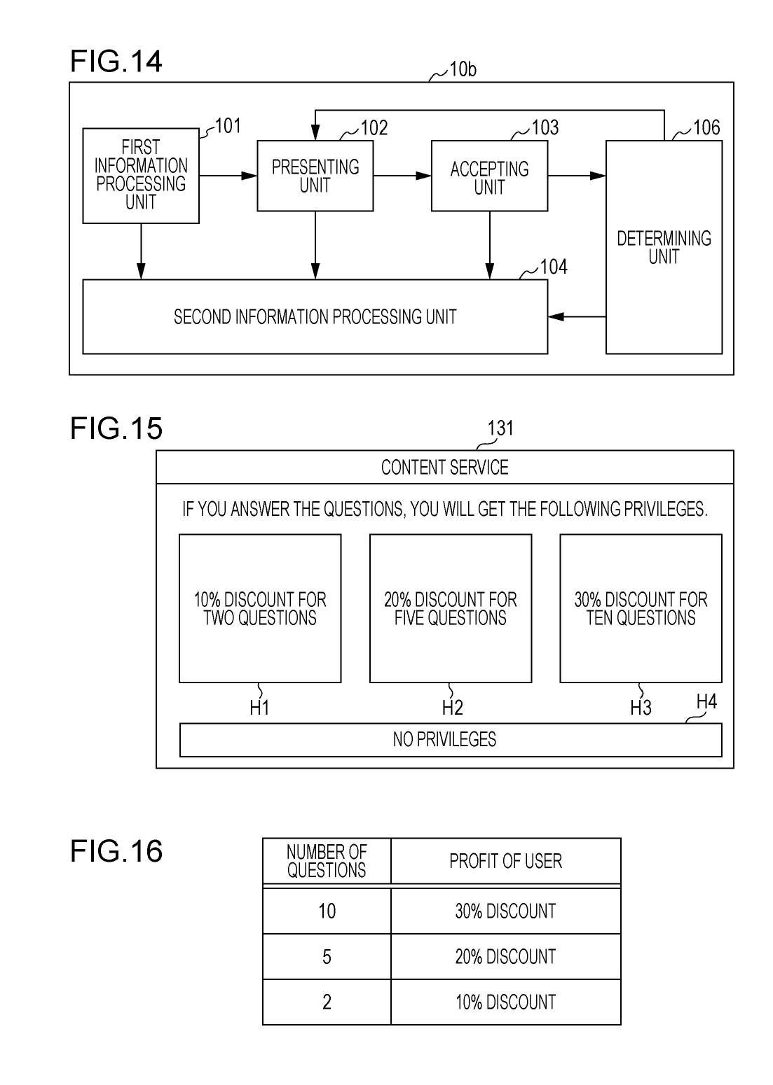

FIG. 14 is a diagram illustrating an example of the functional configuration according to this exemplary modification. FIG. 14 illustrates an image forming apparatus 10b including a determining unit 106, in addition to the units illustrated in FIG. 2. The determining unit 106 is an example of a unit that determines the number of questions to be presented to a user on the basis of a user operation. The determining unit 106 is a function implemented by, for example, the controller 11, the display 13, and the operation unit 14. The controller 11 causes the display 13 to display an image that allows a user to determine the amount of profit (hereinafter referred to as a “determination image”).

FIG. 15 is a diagram illustrating an example of displayed determination images. On the display screen 131, determination images H1, H2, H3, and H4, and a character string “If you answer the questions, you will get the following privileges.” are displayed. The determination images H1, H2, H3, and H4 represent character strings “10% discount for two questions”, “20% discount for five questions”, “30% discount for ten questions”, and “no privileges”, respectively. The controller 11 determines the number of questions in accordance with a determination image that is selected through an operation of the operation unit 14 (for example, in a case where the determination image H1 is selected, the number of questions is determined to be “2”, whereas in a case where the determination image H4 is selected, the number of questions is determined to be “0”). The determining unit 106 notifies the presenting unit 102 and the second information processing unit 104 of the number of questions determined in this way.

The presenting unit 102 presents questions the number of which has been determined by the determining unit 106. The second information processing unit 104 performs, as second information processing, processing for providing a user with a profit whose amount corresponds to the number of questions determined by the determining unit 106. The second information processing unit 104 stores, for example, a profit table in which the numbers of questions and the amounts of profit are associated with each other.

FIG. 16 is a diagram illustrating an example of the profit table. In this example, the profits of a user “30% discount”, “20% discount”, and “10% discount” are associated with the numbers of questions “10”, “5”, and “2”, respectively. The second information processing unit 104 performs, as second information processing, processing for providing a user with a profit associated with the number of questions reported by the determining unit 106 (for example, in a case where the number of questions is “10”, processing for providing a user with a profit “30% discount” is performed as second information processing).

As the number of questions that are presented increases, the possibility that a user stops answering questions increases. In this exemplary modification, the user selects the number of questions on his/her own will. Thus, in a case where the number of questions increases, the possibility that the user answers all the questions increases, compared to a case where the number of questions is not determined on the basis of a user operation.

In the example illustrated in FIG. 15, each determination image represents a specific number of questions. Alternatively, the number of questions may be represented by character strings such as “many”, “standard”, and “few”. Also in this case, the number of questions corresponding to the selected determination image is determined by the determining unit 106. Alternatively, the determining unit 106 may cause the operator image B1 illustrated in FIG. 3A to be displayed, and may determine the number input through a user operation to be the number of questions.

### 7-4. Collection Processing Performed by External Apparatus

In the above-described exemplary embodiments, the second information processing unit 104 performs collection processing by the charging unit 18 as second information processing. Alternatively, for example, the second information processing unit 104 may perform, as second information processing, processing for transmitting charge data representing the amount to be charged on the user to an external apparatus including a unit that performs collection processing. Here, an external apparatus is an apparatus included in a system that performs electronic settlement. That is, collection processing may be performed in any manner as long as the user is provided with a profit through second information processing.

### 7-5. Providing Service in Conjunction with External Apparatus

The first information processing unit 101 may perform first information processing in conjunction with an external apparatus. For example, the first information processing unit 101 outputs, in an image service, an image to a communication terminal of a user, such as a smart phone. In this case, the first information processing unit 101 performs, as first information processing, processing for transmitting image data representing an image of content or the like to a communication terminal via the communication unit 15 and a network or the like to which the communication unit 15 is connected.

### 7-6. Method of not Using Answer Status

In the above-described exemplary embodiments, the second information processing unit 104 performs second information processing in the method using an answer status. Alternatively, the second information processing unit 104 may perform second information processing in the method not using an answer status. For example, in a case where the accepting unit 103 does not accept an answer from a user, the second information processing unit 104 performs processing for collecting a service charge from the user as second information processing. In a case where the accepting unit 103 accepts an answer from a user, the second information processing unit 104 performs processing for discounting a service charge or processing for not collecting a service charge as second information processing. The amount to be discounted at this time may be determined in advance. In this way, by answering questions, the user is capable of acquiring a profit, that is, a discount of a service charge, or no charge for the service. Thus, compared to a case where second information processing according to this exemplary modification dependent on whether or not an answer to a question is accepted is not performed, more answers may be acquired in a case where questions are presented to a user.

### 7-7. Conjunction with Purchase of Item

The first information processing and second information processing performed by the image forming apparatus 10 may be performed in conjunction with purchase of an item by a user.

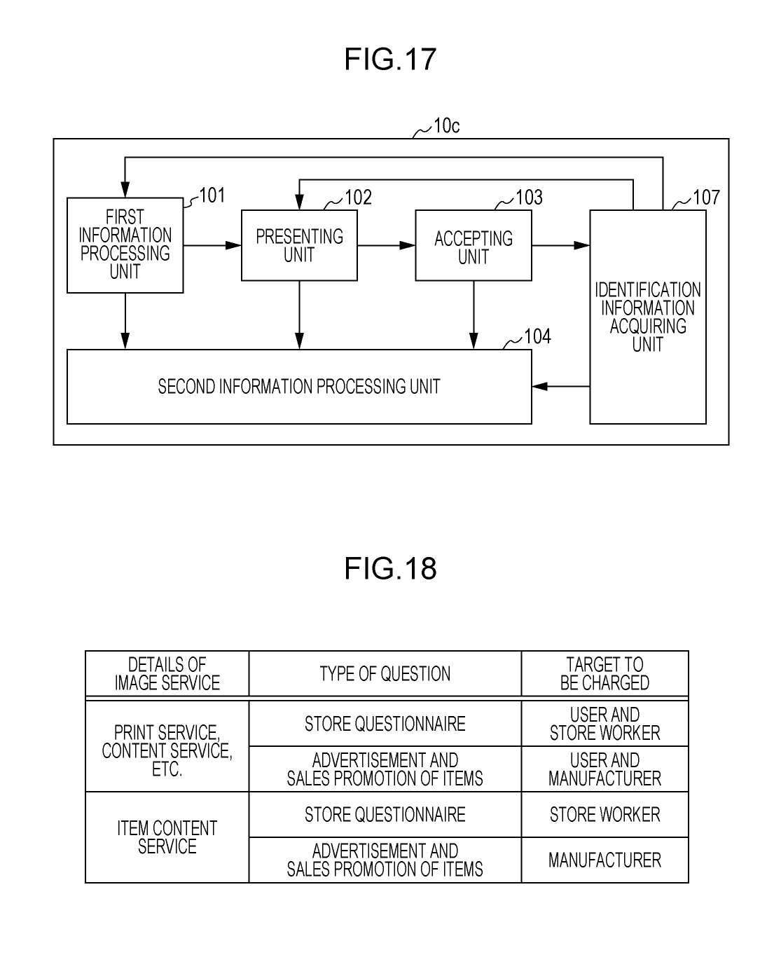

FIG. 17 is a diagram illustrating an example of the functional configuration according to this exemplary modification. FIG. 17 illustrates an image forming apparatus 10c including an identification information acquiring unit 107, in addition to the units illustrated in FIG. 2. The identification information acquiring unit 107 is an example of a unit that acquires identification information identifying an item. The identification information acquiring unit 107 is implemented by, for example, the controller 11, the display 13, and the operation unit 14.

In this exemplary modification, a certain party attaches identification information identifying an item to the item, and sells the item. Specifically, the party attaches a tag having identification information represented by an 8-digit number to an item, and sells the item. The controller 11 causes the display 13 to display an image which allows a user to input identification information of an item. When a user who has purchased an item views the image and inputs the identification information attached to the item, the controller 11 acquires the identification information of the item on the basis of operation data supplied from the operation unit 14. Alternatively, the identification information acquiring unit 107 may acquire, for example, identification information shown on a tag of an item read by the image reading unit 17. The identification information acquiring unit 107 notifies the first information processing unit 101, the presenting unit 102, and the second information processing unit 104 of the acquired identification information.

The first information processing unit 101 performs, as first information processing, processing for providing a user with content regarding an item identified by identification information acquired by the identification information acquiring unit 107. For example, the first information processing unit 101 stores a content table in which identification information of items and content regarding the items are associated with each other, and outputs, to a medium, content associated with identification information reported from the identification information acquiring unit 107 in the content table. For example, in a case where an item is a miniature car, the first information processing unit 101 outputs, as content, a map that is to be used for playing with the miniature car. The first information processing unit 101 may reflect the road condition in the area near the site where the own apparatus is installed in the map output at this time.

The presenting unit 102 presents a question regarding an item identified by identification information acquired by the identification information acquiring unit 107. For example, the presenting unit 102 stores a question table in which identification information of items and questions regarding the items are associated with each other, and presents a question associated with identification information reported from the identification information acquiring unit 107 in the question table.

In a case where identification information is acquired by the identification information acquiring unit 107, the second information processing unit 104 performs, as second information processing, processing for collecting the charge of an image service from a party who deals with the item identified by the identification information. Here, the charge of an image service may be the above-described service charge (that is, the charge determined for the image service) or may be a charge different from the service charge (for example, the charge determined under the contract with the party). The party who deals with the item may be a party who sells the item, or may be a wholesaler or dealer of the item.

In the above-described case, the second information processing unit 104 may perform, as second information processing, processing for not collecting a service charge from a user, or may determine whether or not to perform the processing in accordance with whether or not the accepting unit 103 has accepted an answer from the user. Further, the second information processing unit 104 may perform, as second information processing, various processing operations for providing a user with a profit whose amount corresponds to an answer status, described above in the individual exemplary embodiments and exemplary modifications. That is, the second information processing unit 104 may perform, as second information processing, processing for collecting the charge of an image service from a party who deals with an item identified by identification information, as described above.

In this exemplary modification, a user who has purchased an item operates the image forming apparatus 10, inputs identification information, and answers a question, and thereby acquires content related to the item. At this time, if part or the whole of the charge of the content related to the item is collected from a party who deals with the item, a burden of paying a charge for acquiring the content imposed on the user is reduced, compared with a case where the second information processing according to this exemplary modification is not performed. Further, since the content relates to the item purchased by the user, the user is more interested in the content than in content related to another item. Due to an experience in which the user has acquired content which the user is very interested in with a small burden, the user is more likely to purchase an item to which identification information is attached, compared to a user who does not have such an experience. Accordingly, in this exemplary modification, sale of items is promoted compared to the case of not performing second information processing using identification information of an item.

### 7-8. Target from which Charge is Collected

The second information processing unit 104 may perform, as second information processing, processing for collecting the charge of an image service from a party corresponding to the details of the image service provided in the first information processing performed by the first information processing unit 101 or the question presented by the presenting unit 102. The second information processing unit 104 stores, for example, a target table in which the content of image services, questions, and targets from which the charge of an image service is to be collected are associated with one another.

FIG. 18 is a diagram illustrating an example of the target table. In this example, in a case where the details of an image service indicate “print service, content service, etc.”, the types of question “store questionnaire” and “advertisement and sales promotion of items” are associated with the targets from which the charge is to be collected “user and store worker” and “user and manufacturer”, respectively. In a case where the details of an image service indicate “item content service”, the types of question “store questionnaire” and “advertisement and sales promotion of items” are associated with the targets from which the charge is to be collected “store worker” and “manufacturer”, respectively. “Item content service” is a service of outputting content related to an item described in the above exemplary modification.

In this exemplary modification, the presenting unit 102 notifies the second information processing unit 104 of a presented question. The second information processing unit 104 performs, as second information processing, processing for collecting the charge of an image service from a target associated with the details of the image service reported from the first information processing unit 101 and the question reported from the presenting unit 102 in the target table.

In this exemplary modification, a target from which the charge of an image service is to be collected is determined in accordance with the details of a provided image service and a presented question. The method for determining a target may be defined in accordance with the relationship with individual questions (for example, the ratio of the number of prepared questions) among a party who wants to utilize the answers from users for marketing and a party who wants to utilize the answers for sales promotion of items.

### 7-9. Answer to Remaining Questions

In a case where the number of questions presented by the presenting unit 102 is determined, provision of an image service may be finished before the answers to all the questions are made. In this case, the presenting unit 102 may output one or more remaining questions to a medium to present them to a user, or may present one or more remaining questions to the user when the user utilizes an image service next time by using the above-described user identification information. Alternatively, the presenting unit 102 may output an electronic marker such as a quick response (QR) code indicating an access destination of the own apparatus to a medium, and a user may read the electronic marker by using a smart phone or the like to access the apparatus, so that remaining question are presented. Alternatively, the presenting unit 102 may directly transmit question data representing one or more remaining questions to a smart phone or the like of the user. In this case, an e-mail address registered in advance by the user, or an access destination of the user registered in an image service utilized by the user may be used as an access destination.

### 7-10. Amount of Profit

A factor that determines the amount of profit to be provided to a user is not limited to that described above. For example, in a case where an answer to a presented question is an answer to be made by freely inputting characters or the like, not an answer that is selected from among options, the amount of profit may be determined in accordance with the number of input characters. In this case, the amount of profit may be determined in accordance with whether or not the characters include a determined keyword. For example, if the characters include the keyword, the charge of an image service is discounted by 30%, and, if the characters do not include the keyword, the charge of an image service is discounted by 10%.

### 7-11. Progress Status of Service Processing

The presenting unit 102 may notify a user of the progress status of service processing using a method different from the method of displaying the progress status image E1 illustrated in FIGS. 3A and 3B. For example, the presenting unit 102 may display an image of an hourglass, and may represent the end of service processing by displaying an image in which all sands in the hourglass have run out. Alternatively, the presenting unit 102 may display a countdown image, and represent the end of service processing by displaying the numeral “0”. Alternatively, the presenting unit 102 may sequentially display images representing the processes executed in service processing. Alternatively, the presenting unit 102 may present the progress status of service processing using sound.

### 7-12. End Timing of Service Processing

In a case where the number of questions presented to a user is determined, the first information processing unit 101 may estimate the time when answering to the questions finishes, and may perform service processing by making adjustment so that the service processing finishes at the estimated time. The first information processing unit 101 estimates the time when answering to the questions finishes by using, for example, the above-described answering time. In the case of providing a service of outputting images to plural media, for example, the first information processing unit 101 may output the last medium in response to a user operation of answering to the last question. According to this exemplary modification, it is not necessary for the user to answer to a question after a service has been provided.

### 7-13. Information Processing Apparatus and Service Provided to User

An exemplary embodiment of the present invention is applicable to an information processing apparatus, as well as an image forming apparatus. For example, an exemplary embodiment of the present invention is applicable to an information processing apparatus such as a kiosk apparatus that provides a user with a certain service. Examples of the kiosk apparatus include a terminal that is installed in a restaurant or the like and receives orders, a terminal that is installed in a tourist spot and guides tourist attractions, and a terminal that is installed at a station or public facilities and guides facilities. Also, an exemplary embodiment of the present invention is applicable to an information processing apparatus such as office automation equipment or an apparatus that displays an advertisement on a touch screen.

The service provided to a user is not limited to the above-described image service. In a case where the above-described kiosk terminal is used as an information processing apparatus, services such as acceptance of an order of an item, guidance of tourist attractions, and guidance of facilities are provided to a user. In this way, any service may be provided by an information processing apparatus as long as the service is useful to a user. That is, any types of information processing apparatus may be used as long as the information processing apparatus implements the units illustrated in FIG. 2.

### 7-14. Operation Based on Certain Matter

The tables used in an operation and illustrated in FIG. 4 and so forth are not limited to those illustrated in the figures. For example, the number of rows in each table is not limited, as long as the number is two or more. The items arranged in ascending order (or descending order) may be rearranged in descending order (or ascending order) or may be rearranged randomly. Alternatively, without using a table, the items in individual cells may be represented by numerals, and a value calculated by using an equation may be used. For example, in the example illustrated in FIG. 4, a value resulting from multiplying the number of answers by 3% (for example, if the number of answers is 5, the calculated value is 15%) is discounted, which is a profit of a user. That is, in this operation, a matter (in the example illustrated in FIG. 4, a profit of a user) may be determined in accordance with another matter (in the example illustrated in FIG. 4, the number of answers).

### Categories of the Invention

An exemplary embodiment of the present invention may be implemented as an information processing apparatus such as an image forming apparatus, and also as an information processing method for realizing processing performed by the information processing apparatus. Here, an example of the processing is the charging processing illustrated in FIG. 5. Furthermore, an exemplary embodiment of the present invention may be implemented as a non-transitory computer readable medium, such as an optical disc, storing a program causing a computer such as an information processing apparatus to implement the functions of the units illustrated in FIG. 2 and so forth. Alternatively, the program may be provided by being downloaded to a computer via a network such as the Internet and being installed into the computer so that the program is available.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first information processing unit that performs first information processing for providing a user with a service;
a presenting unit that presents a question to the user, who utilizes the service provided in accordance with the first information processing performed by the first information processing unit;
an accepting unit that accepts an answer to the question presented by the presenting unit from the user; and
a second information processing unit that performs second information processing regarding a charge for the service, the second information processing unit performing, as the second information processing, processing for collecting a determined charge for the service from the user in a case where the accepting unit does not accept an answer from the user, and the second information processing unit performing, as the second information processing, processing for discounting the determined charge or processing for not collecting the determined charge in a case where the accepting unit accepts an answer from the user.

2. The information processing apparatus according to claim 1, further comprising:
an identification information acquiring unit that acquires identification information identifying an item, wherein
the first information processing unit performs, as the first information processing, processing for providing the user with content regarding the item identified by the identification information acquired by the identification information acquiring unit,
the presenting unit presents a question regarding the item identified by the identification information acquired by the identification information acquiring unit, and
the second information processing unit performs, as the second information processing, processing for collecting the charge for the service from a party who deals with the item identified by the identification information in a case where the identification information is acquired by the identification information acquiring unit.

3. The information processing apparatus according to claim 1, wherein
the second information processing unit performs, as the second information processing, processing for providing the user with a profit whose amount corresponds to a status of an answer accepted from the user, the processing being processing for discounting the determined charge in accordance with a status of an answer accepted from the user, or processing for not collecting the charge in accordance with the status.

4. The information processing apparatus according to claim 1, wherein
the second information processing unit performs, as the second information processing, processing for providing the user with a profit whose amount corresponds to a status of an answer accepted from the user, the processing being processing for outputting value information representing a value that is utilized in commercial transactions and that has an amount corresponding to a status of an answer accepted from the user.

5. The information processing apparatus according to claim 1, wherein
the second information processing unit performs, as the second information processing, processing for providing the user with a profit whose amount corresponds to a status of an answer accepted from the user, the processing being processing that is selected by the user from among processing for discounting the determined charge in accordance with a status of an answer accepted from the user, processing for not collecting the charge in accordance with the status, and processing for outputting value information representing a value that is utilized in commercial transactions and that has an amount corresponding to the status.

6. The information processing apparatus according to claim 3, further comprising:
a determining unit that determines the number of questions presented to the user, in accordance with an operation performed by the user, wherein
the presenting unit presents questions the number of which is determined by the determining unit, and
the second information processing unit performs, as the second information processing, processing for providing the user with a profit whose amount corresponds to the number determined by the determining unit.

7. The information processing apparatus according to claim 3, wherein
the second information processing unit performs, as the second information processing, processing for changing an amount of the profit in accordance with a type or details of a service provided in accordance with the first information processing performed by the first information processing unit.

8. The information processing apparatus according to claim 3, further comprising:
an attribute acquiring unit that acquires an attribute of the user, wherein
the second information processing unit performs, as the second information processing, processing for changing an amount of the profit in accordance with a relationship between the attribute acquired by the attribute acquiring unit and content of the question presented by the presenting unit or the answer accepted by the accepting unit from the user.

9. The information processing apparatus according to claim 3, wherein
the second information processing unit performs, as the second information processing, processing for changing an amount of the profit in accordance with a relationship between a site where the information processing apparatus is installed and content of the question presented by the presenting unit or the answer accepted by the accepting unit from the user.

10. An information processing apparatus comprising:
an identification information acquiring unit that acquires identification information identifying an item;
a first information processing unit that performs first information processing for providing a user with content regarding the item identified by the identification information acquired by the identification information acquiring unit;
a presenting unit that presents, to the user, who utilizes a service provided in accordance with the first information processing performed by the first information processing unit, a question regarding the item identified by the identification information acquired by the identification information acquiring unit;
an accepting unit that accepts an answer to the question presented by the presenting unit from the user; and
a second information processing unit that performs second information processing regarding a charge for the service, the second information processing unit performing, as the second information processing, processing for collecting a determined charge for the service from the user in a case where the accepting unit does not accept an answer from the user, and the second information processing unit performing, as the second information processing, processing for collecting the charge for the service from a party who deals with the item identified by the identification information in a case where the accepting unit accepts an answer from the user.

11. An information processing method comprising:
performing first information processing for providing a user with a service;
presenting a question to the user, who utilizes the service provided in accordance with the first information processing;
accepting an answer to the presented question from the user; and
performing second information processing regarding a charge for the service, the second information processing being processing for collecting a determined charge for the service from the user in a case where an answer is not accepted from the user, and processing for discounting the determined charge or processing for not collecting the determined charge in a case where an answer is accepted from the user.

12. A non-transitory computer readable medium storing a program causing a computer to execute a process, the process comprising:
performing first information processing for providing a user with a service;
presenting a question to the user, who utilizes the service provided in accordance with the first information processing;
accepting an answer to the presented question from the user; and
performing second information processing regarding a charge for the service, the second information processing being processing for collecting a determined charge for the service from the user in a case where an answer is not accepted from the user, and processing for discounting the determined charge or processing for not collecting the determined charge in a case where an answer is accepted from the user.
